(19) United States
(12) Patent Application Publication
(10) Pub. No.: US 2004/0030887 A1
(43) Pub. Date: Feb. 12, 2004

(54) System and method for providing secure communications between clients and service providers

(76) Inventors: Carol L. Harrisville-Wolff, Louisville, CO (US); Jeff S. Demoff, Erie, CO (US); Alan S. Wolff, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/213,765

(22) Filed: Aug. 7, 2002

(51) Int. Cl. H04L 9/00

(52) U.S. Cl. 713/155

(57) ABSTRACT

A method for secure network communications. The method includes receiving at the service provider a request from a client that includes an identifier (e.g., a digital certificate) for the client. The identity is authenticated by the service provider by retrieving a stored copy of a digital certificate for the client sending the request and comparing the copy of the digital certificate included with the request to the stored copy. If authenticated, access to the service provider is granted and typically, a response is generated and transmitted to the client that includes an identifier or a digital certificate for the service provider. The client then authenticates the service provider by comparing the certificate with a stored copy prior to transmitting further messages. The method includes encrypting and decrypting the requests and the responses using private and public key pairs associated with the stored digital certificates.

### BACKGROUND OF THE INVENTION

1. Field of the Invention

The present invention relates, in general, to secure communications between computers or electronic devices and, more particularly, to software, systems and methods for providing two-way, symmetric verification in a computer network between clients and service providers.

2. Relevant Background

The need for secure communications within computer networks between service providers and clients is becoming more pressing as the number and types of uses of computer networks, such as the Internet, continues to rapidly expand. Computer networks have emerged as the most significant medium for conducting electronic commerce and other types of transactions, such as remote banking, remote business transactions (e.g., remote purchases of products and services), and transferring private information (e.g., electronic mail). During electronic commerce and other private communications, one or both parties transfers information that must be protected to ensure the integrity and validity of such transactions. The transferred information may include personal identification information for the user such as social security numbers and may include confidential information, such as bank account and charge card account numbers and personal identification numbers, that if stolen could readily be used to access the users accounts. For electronic commerce and private communications (i.e., secure transactions) to continue and expand on computer networks, there is a strong need for the risks associated with these communications to be eliminated or significantly reduced.

Presently, the majority of network communications are made “secure” by allowing a user or client device (such as a e-commerce purchaser or bank customer) using a browser on their computer or electronic device to determine that they are communicating with a particular service provider (such as an e-commerce business or an online banking service). Once the service provider is authenticated, the communications to the service provider are often made more secure by the user device encrypting messages prior to transmittal over the network. More specifically, the majority of secure transactions over the Internet occur via a technology developed by Netscape Communications Corporation labeled Secure Sockets Layer (SSL), which has become the standard for authenticated and encrypted client-server communications via HyperText Transfer Protocol (HTTP). To operate securely, SSL requires a certificate (e.g., a digital certificate or digital ID) and these digital certificates are typically issued by a trusted third party known as a certificate authority (such as VeriSign, Inc. or Thawte Consulting). From a user's perspective, the certificate signifies that an independent party (i.e., the certificate authority) has verified that the information in the certificate accurately represents whom it claims to represent and the communications can be encrypted using the certificate's key(s). The certificate attempts to ensure that the user is actually communicating with the service provider's host domain name and not with an imposter.

As further background, the service provider operates pre-installed software for generating a public/private key pair and sends a certificate request including the public key to the certificate authority. The certificate authority verifies the identity and any other information needed about the service provider, packages the service provider's name, the public key, a validity period and an assigned serial number together, and digitally signs the package, thereby creating a signed certificate. The certificate authority then sends the signed certificate to the service provider, who installs the signed certificate and the private key associated with the packaged public key in one or more web servers.

For completeness, a brief review of public/private key cryptography is provided. Mathematically, a public and private key pair is generated to encrypt and decrypt messages. That is, either key can be used to encrypt a message, but only the other key of the key pair can be used to decrypt the message. The owner, such as the service provider, keeps the private key private, but allows everyone to know the public key. Accordingly, anyone can encrypt a message using the public key (including the e-commerce client), but only the owner can decrypt the message, because the owner is the only one who knows the private key. Similarly, the owner can encrypt a message using the private key, and thus everyone can use the public key to decrypt the message. A user that uses a public key to decrypt an encrypted message can be sure that the message was encrypted by someone who has the corresponding private key. So long as the private key is kept private, the user can be assured that the owner of the private key sent the message.

When a web client connects to a web server operated by the service provider, the web client identifies and authenticates the web server to “secure” a communications channel. For identification, the service provider provides a signed public key certificate and the web client uses the certificate to verify the authenticity of the service provider. The public key certificate binds a public key to a subject name (i.e., distinguished name) such as the service provider's name or service provider server's name. The certificate authority signs all certificates it issues with a private key and the corresponding certificate authority public key is itself contained within a certificate, called a certificate authority certificate. The web client's browser must, therefore, contain the certificate authority certificate in order to trust or verify certificates from service providers that are signed by the certificate authority's private key.

While providing some measure of security, there are a number of problems with the present SSL communications model. The present model is only a one-way authentication process. In other words, only the web client authenticates that date from the service provider server is secure and trusted. Web clients are not required to authenticate themselves and hence, the service provider server has no way of telling whether or not a client is “valid.” Often, the service provider assumes the client or customer is authentic as long as their personal and/or account information is accurate and communications are encrypted using the service provider's public key. However, there are numerous well-known ways in which this information can be obtained (such as the interception of web client transmissions, changing trusted DNS tables, and the like), and then an imposter client can access the service provider system and make unauthorized transactions (e.g., purchases, balance transfers, and the like). Certain transactions and information transfer may also be barred across certain geographic or political boundaries, and an imposter client in an embargoed or barred location or in an insecure domain can send false information, such as IP addresses, domains, locale, and the like, that typically will not be detected by the service provider server. Some highly secure transmissions (such as between banks and between banks and government systems) are protected by each party directly exchanging one or more keys but large scale exchange of keys directly between service providers and web clients is too inconvenient and impractical for the e-commerce environment.

Hence, there remains a need for an improved method and system for providing secure transactions and communications between clients and service providers or between any two devices that are using digital communications. Preferably, such a system and method would be inexpensive to implement, non-intrusive to install and operate, and compatible with existing and yet to be developed encryption and authentication technologies.

### SUMMARY OF THE INVENTION

The present invention addresses the above problems by providing a two-way, symmetric verification method for use in performing secure communications and transactions within a computer network. Briefly, in the method of the invention, networked service providers (such as ISPs and/or web and application servers) establish digital identification or certificates for clients authorized to access their services, system, or data. In one embodiment, third party certificate authorities are contracted to assign digital certificates to authorized clients and to the service provider. During communications or transactions (such as over the Internet or other communications network), both the clients and the service providers include a copy of their digital certificates with communications, e.g., posted requests, responses, and the like, and the receiving clients or service provider functions to compare the received digital certificate with a stored copy of the clients' or service provider's digital certificate received from the certificate authority. Hence, two-way rather than one-way verification of identities is achieved to make communications and transactions more secure.

More particularly, a computer-based method is provided for providing secure communications between a service provider and clients (or any two devices communicating by transmitting digital data). The method includes receiving at the service provider a request from a client that includes an identifier (e.g., a digital certificate) for the client. The service provider then authenticates the identity by processing the received identifier. In one embodiment, authentication includes retrieving a stored copy of a digital certificate for the client sending the request and comparing the copy of the digital certificate included with the request to the stored copy. If authenticated, access to the service provider is granted and typically, a response is generated and transmitted to the client that includes an identifier (e.g., a digital certificate) for the service provider. The client then authenticates the service provider by comparing the received digital certificate with a stored copy prior to transmitting any further messages to the service provider. The method may also include encrypting and decrypting at the client and the service provider the requests and the responses using private/public key pairs associated with the digital certificates stored at the client and service provider.

### BRIEF DESCRIPTION OF THE DRAWINGS

FIG. 1 illustrates in block diagram form a secure communication system in which the present invention is implemented;

FIG. 2 illustrates in block diagram form basic features of a secure communication system in accordance with the present invention;

FIG. 3 is a flow chart illustrating functions performed by a service provider system during initialization for providing secure communications with clients; and

FIG. 4 is a flow chart illustrating functions performed during typical operations of a secure communications system, such as the ones shown in FIGS. 1 and 2.

### DETAILED DESCRIPTION OF THE PREFERRED EMBODIMENTS

In general, the present invention is directed to a secure communications method and system that differ from prior one-way authentication techniques by providing two-way validation of service providers (such as Internet service providers (ISPs) or servers providing a service or access to data) and client devices (such as individual users, other service providers, business entities, and the like) linked for digital data communications and transactions, such as by a communications network like the Internet. The method, and system implementing such method, is adapted to allow the service provider (at an ISP, Web server, or other communication interface device) to validate the identity of clients, such as with distributed computing methods including, but not limited to Jini™ and Java™, and allow the clients to likewise validate the identity of the service provider. Such a two-way validation is very useful in performing highly sensitive communications and transactions over public communication networks, such as the Internet. In this fashion, ISPs and/or Web sites of service providers can require that their clients be validated before accessing their site which provides an additional level of security for the clients' information (such as account information accessed at the Web site), the clients' assets (such as financial assets managed by the service provider), and the service providers' information and assets (e.g., from imposter clients attempting to improperly access a Web site, purchase goods with a false identification, and the like). The specific method of validation and/or encryption and decryption utilized is not limiting of the invention with the key feature being the two-way validation of the service provider and the clients.

In one illustrative embodiment, the secure communications method involves the following steps or functions. A client contacts a given service provider, via their ISP or Web site. The service provider would determine if the client is new or needs to be registered for access. If new, the service provider (or their ISP) collects identification information from the client and then contacts a certificate authority to obtain public and private keys for encryption and decryption and a digital certificate allowing authentication of the client. Prior to this step, the service provider would contract with the certificate authority to provide such an authentication and certificate service for their clients (who, in some embodiments, can contact the certificate authority directly to obtain the keys and certificate). The keys and certificate are generated by the certificate authority and reserved only for that client (and matched to the service provider and client). The keys and certificate are transferred to the client (such as via a traditional SSL connection or the like) from the service provider or certificate authority for storage and installation locally. The service provider (or its ISP) would also obtain keys and a certificate from the certificate authority and would store a copy of the client's keys and certificate in memory (e.g., in or associated with an authorized client registry).

When a registered client posts a request, such as an HTTP request, to the service provider, the service provider can validate the request prior to allowing access. The client makes its requests while concurrently passing its certificate (and, typically, the request and certificate are encrypted) to the service provider. The service provider (via its ISP, Web server, or other tools) checks its authorized client registry for the requesting client, if the request is from an authorized client the service provider retrieves the stored client certificate and public key, and then the service provider attempts to validate the client's identification by comparing the client-transmitted certificate with the stored client certificate. If the client cannot be validated, the client request is rejected and entry to the service provider is refused. If validated or authenticated, the client is granted access and, typically, a response is transmitted to the client from the service provider along with the service provider's certificate. The client can then authenticate the service provider's identity by comparing the certificate with one stored in its memory and/or by contacting the certificate authority to determine if the certificate can be “trusted.” In some embodiments, actions taken by the service provider are logged for later use. In many embodiments, the secure communications method of the invention is implemented with software that is based on a distributed computing model that allows it to be platform independent so that the secure communications method can be run as a plug in in nearly any computing system, such as typical Web or application server. As will become clearer from the following more detailed description, the secure communications method of the invention may be invaluable to many ISPs and service providers that seek secure connections over networks, such as the Internet, that would have significantly reduced risks of accessing or hacking by unauthorized clients.

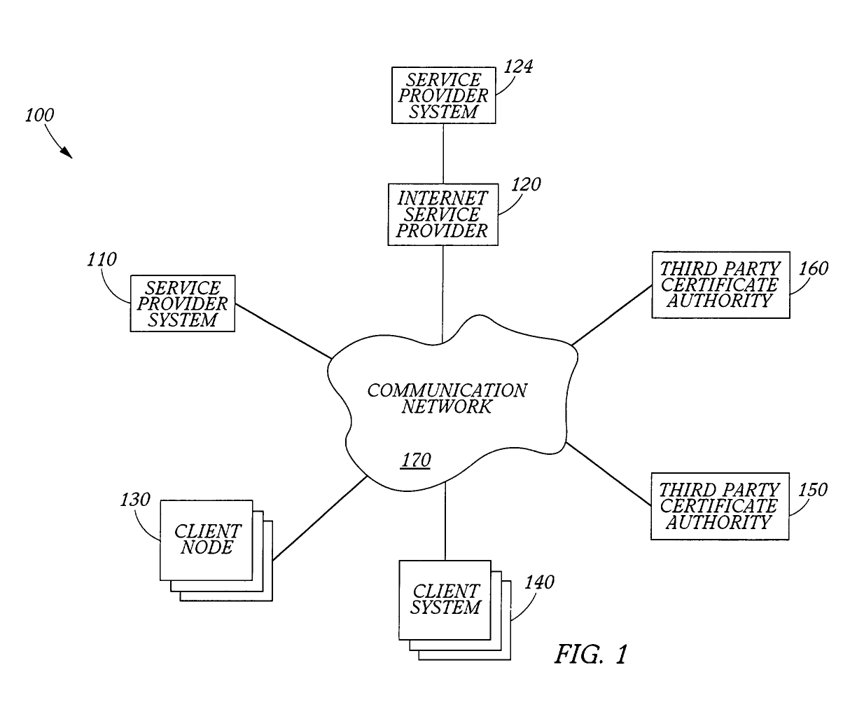

FIG. 1 illustrates in schematic form a secure communications system 100 in which the two-way secure communication methods of the invention can be implemented to provide secure communications between multiple clients and service providers linked by a communication network. The methods and/or functions of the invention can be implemented using numerous electronic and computer devices (e.g., a variety of hardware) and with one or more applications or software programs useful for performing the underlying, described tasks (e.g., Web browsers, text editors, graphical user interfaces, communication managers, database and memory managers, and many more software tools well-known in the computer arts). As illustrated, the system 100 includes a number of client nodes 130, client systems 140, a service provider system 110, and a service provider 124 with an ISP 120 that are in communication via a communication network 170 (e.g., the Internet, a LAN, a WAN, and the like) and communication links (e.g., any suitable data communication link, wired or wireless, for transferring digital data between two electronic devices). The service provider system 110 and service provider 124 function to provide services and/or manage data (e.g., any useful e-commerce service or products including financial services, product or service sales, and the like). The clients 130, 140 represent devices used by individuals, business or other entities, or even other service providers to access and communicate with the service providers 110, 124.

In the following discussion, computer and network devices, such as user or client nodes and systems 130, 140, service providers 110, 124, and third party certificate authorities 150, 160, are described in relation to their function rather than as being limited to particular electronic devices and computer architectures. To practice the invention, the computer devices and network devices may be any devices useful for providing the described functions, including well-known data processing and communication devices and systems such as personal digital assistants, personal, laptop, and notebook computers with processing, memory, and input/output components, and server devices configured to maintain and then transmit digital data over a communications network. Data, including client requests and service provider responses, is typically communicated in digital format following standard communication and transfer protocols, such as TCP/IP, HTTP, HTTPS and the like, but this is not intended as a limitation of the invention, and in many embodiments, the transferred data is encrypted using public/private key or other techniques for added security.

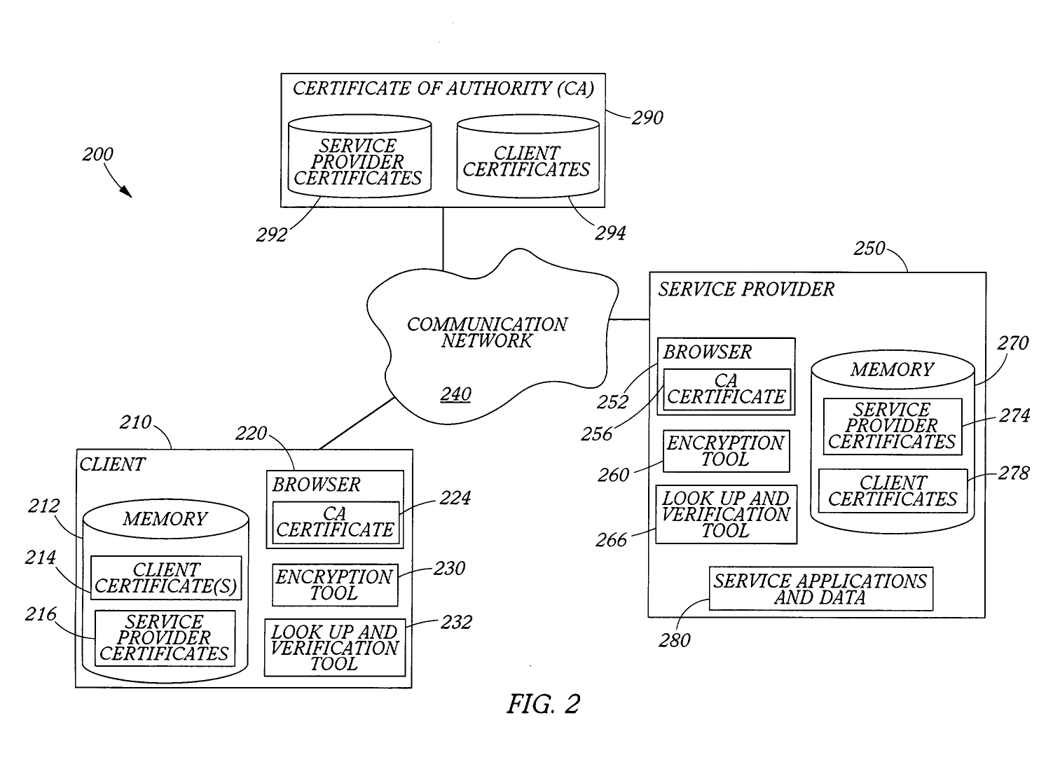

During operation of the system 100, transactions and communications are made secure by both the service providers 110, 124 (or the ISP 120 for service provider 124) and the clients 130, 140 using validation tools (described in more detail with reference to FIGS. 2-4) to validate the identity of the other party to the transaction or communication. Such verification can be done in a number of ways according to the invention. In the illustrated embodiment, the service providers 110, 124 (or ISP 120) contract with one or both of the certificate authorities 150, 160 to provide digital certificates and encryption/decryption keys to the service providers 110, 124 and to authorized clients 130, 140 who request access to the service providers 110, 124. During communications, the service providers 110, 124 (or the ISP 120 for service provider 124) and the clients 130, 140 transmit data (such as HTTP requests and responses via the SSL that are typically encrypted using the keys) along with the certificates assigned by the certificate authority 150, 160 (e.g., VeriSign, Inc., Thawte Consulting, or other trusted third party certificate authority). Typically, the service provider 110 and the ISP 120 will store an authorized client list in memory along with a digital certificate and keys for each client 130, 140 on the list. The clients 130, 140 use a digital certificate installed for a particular service provider system 110 or 124 to identify them to the service provider 110, 124 (or ISP 120) and compare certificates received from the service providers 110, 124 (or ISP 120) to authenticate the identity of the service provider 110, 124. Hence, two-way authentication or validation of identities is achieved in the system I 00 to allow communications and transactions to be performed with reduced risk of interception or access by imposters.

FIG. 2 provides a more detailed illustration of a simplified secure communication system 200 including components useful for implementing the two-way authentication technique of the present invention. As shown, a client 210 is linked to a service provider 250 (such as a Web server or an ISP and a Web or application server) via a public communication network 240 (e.g., the Internet). A certificate authority 290 is also linked to the network 240 to communicate with the service provider 250 and the client 210. The certificate authority 290 functions to process certificate requests from the service provider 250 (or directly from the client 210), to verify identities of the service provider 250 and the client 210, and to issue digital certificates. The certificate authority 290 stores copies of issued digital certificates and associated keys in memory as service provider certificates 292 and client certificates 294. The certificate authority (CA) 290 signs all certificates 292, 294 with its private key and issues its own CA certificate with the public key to allow the CA signature to be decrypted or “trusted.” The digital certificates 292, 294 bind a public/private key pair to a name (of a service provider 250 or client 210) to provide a digital identity. The digital certificates 292, 294 are used to verify that the public key belongs to a particular service provider 250 or client 210. A typical or conventional certificate 292, 294 includes a user name, a certificate validity date, a public key, an identifier or name for the certificate authority 290, and the digital signature of the certificate authority 290.

The client 210 is configured for transmitting requests over the communications network 240 to the service provider 250 and for authenticating or validating the identity of the service provider 250. To this end, a browser 220 is provided with an installed CA certificate 224 from the certificate authority 290 that allows it to verify a digital signature in certificates received from the service provider 250 and other entities. During operation, the client 210 will receive a client certificate 214 which it will install and/or store in memory 212. The client certificate 214 is issued by the certificate authority 290 as part of an initial registration process required by the service provider 250 or prior to attempting access to the service provider 250. In larger systems with multiple service providers 250, the client 210 may be assigned and store multiple client certificates 214 associated with each provider 250 (and, in some cases, assigned by different certificate authorities 290 contracted by the service provider 250). Typically, the certificate will include a public key for the client 210 and a private key for use by the client in encrypting requests or other messages is also stored in memory 212. The client 210 may also store a service provider certificate 216 (e.g., a digital certificate issued by the certificate authority 290) in memory 212 for use in authenticating or validating messages received from the service provider 250 (or alternatively, the certificate authority 290 may be contacted during service provider 250 verification) and in larger systems, certificates 216 may be stored for each service provider.

An encryption tool 230 is provided for encrypting messages or requests transmitted by the client 210 (such as HTTP requests encrypted using the private key associated with the client certificate) and for decrypting received messages from the service provider 250 (such as HTTP requests decrypted using the public key associated with the certificate 216 for the service provider 250). A look up and verification tool 232 is provided to determine if the service provider 250 is recognized as an expected provider, to retrieve a corresponding certificate 216, and to compare certificates received in responses from the provider 250 with stored certificates 216 issued by the certificate authority 290. During operations, the client 210 is configured to transmit requests with the client certificate 214 identifying the client 210 to the service provider 250 and to process responses from the service provider 250 to validate the identity of the service provider 250.

The service provider 250 is configured to validate the identity of the client 210 prior to granting access to service applications or data 280. To this end, the service provider 250 includes a browser 252 with a CA certificate 256 containing a public key from the certificate authority 290. In memory 270, the service provider 250 stores its digital certificate 274 (and keys) which it includes with messages it transmits to the client 210 and which it receives from the certificate authority 290. Additionally, client certificates 278 with keys received from the certificate authority 290 for each “authorized” client 210 are stored in memory 270 for use in validating the identity of clients 210 posting requests to the service provider 250. An encryption tool 260 is provided for using the private key associated with the certificate 274 to encrypt messages sent from the service provider 250 to the client 210 and to decrypt messages or requests received from the client 210 with public keys associated with the client certificates 278 and the CA certificate 256. A look up and verification tool 266 is provided in the service provider 250 for, upon receipt of client request from client 210, searching memory 270 (or an authorized user registry) to determine if the client 210 is an authorized user, if authorized retrieving a client certificate 278 associated with the requesting client 210, and comparing a client digital certificate 214 received with the client request with the client certificate 278 stored in memory 270 for the client 210. Once verified, the client 210 is granted access to the service applications and data 280, as appropriate, and a two-way verification or authentication is achieved in the system 200.

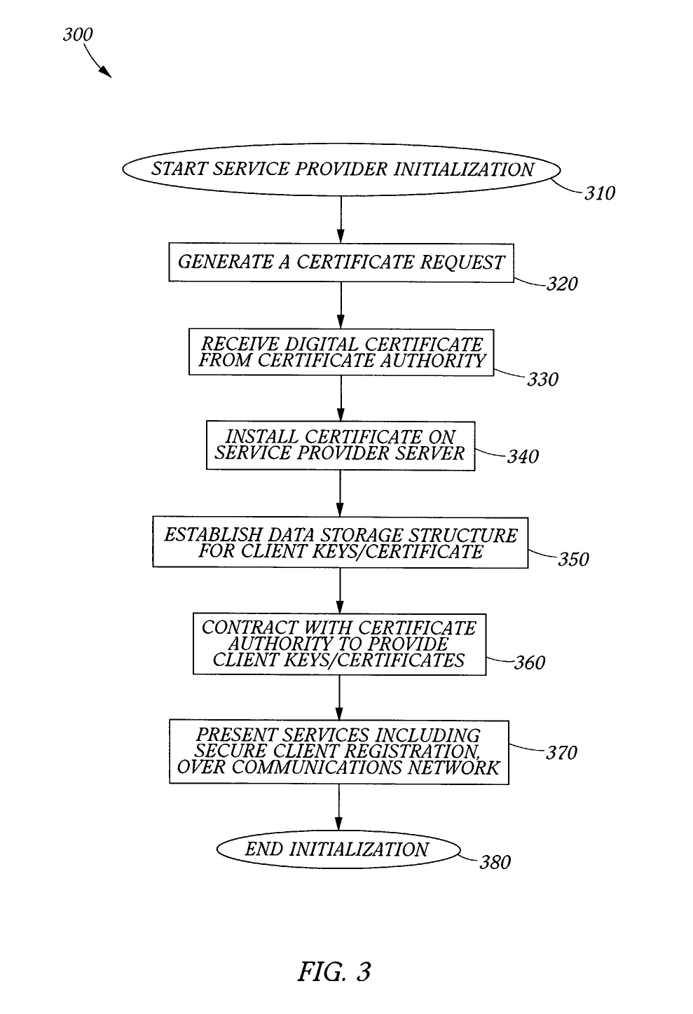

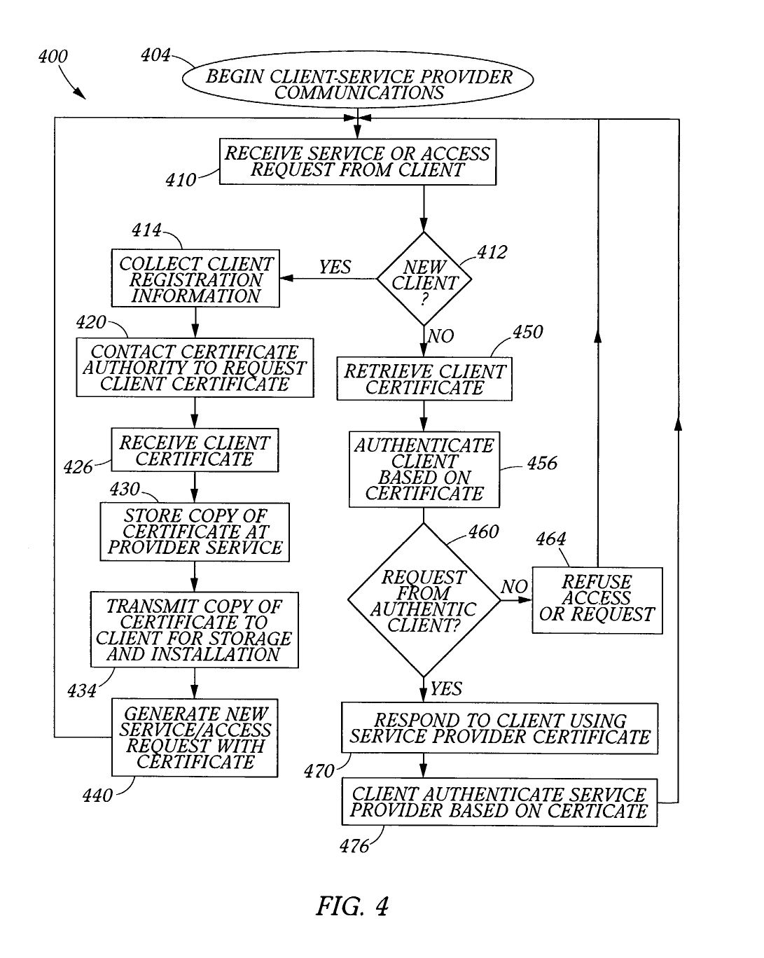

FIGS. 3 and 4 provide exemplary functions or steps carried out by the components of a secure communications system of the invention (such as system 200). FIG. 3 illustrates an initialization process 300 carried out by or at the service provider system 250. The service provider initialization 300 is started at 310 with the determination of how to verify clients 210 attempting to access the service provider 250. In one embodiment, the client's 210 are required to provide digital certificates with their requests which the service provider 250 can issue or typically are issued by a trusted third party (such as a certificate authority 290). The service provider 250 also transmits an identifier, such as a digital certificate, with its messages to allow clients to validate the service provider 250. Typically, the client and the service provider certificates are issued by the same certificate authority and messages are also encrypted using public/private key pairs or some other useful encryption method.

With a certificate authority selected, the process 300 continues with the service provider 250 (or an ISP) generating a certificate request 320 that is transmitted to the certificate authority 290. In embodiments using a private and public key pairs, a private key is typically generated at this point and stored in a private key file (that is often protected further with the use of a password). Tools, such as SSL Tools and CSR Utility, can be used for generating a private key and for creating and transmitting the certificate request. The certificate request generally includes information identifying the service provider 250 or other requester including a common name (such as the host name of an SSL server and often the name used with a corresponding DNS server), organization name, address, e-mail address, telephone and facsimile numbers, and a file name for the private key. The request at 320 often includes a proof or right to use or other information that the certificate authority 290 requests to verify the requesting party's identity. At 330, the certificate authority 290 sends a digital certificate (which it stores at 292) to the service provider 250 and includes a public key that is reserved for the service provider 250 and paired with the service provider private key. At 340, the service provider 250 installs and/or stores the service provider certificate 274 for use in transmission to requesting clients 210.

At 350, the service provider 250 (or an ISP) establishes a data storage structure (such as 278) for storing client keys and digital certificates (or other identifiers used to verify the identity of clients 210). The service provider 250 then arranges with the certificate authority 290 for the authority 290 to verify the identity or right to use of clients 210 which request access to the service provider 250 and to issue keys and certificates 294 to the clients 210. In many embodiments, the service provider 250 will contract with the authority to pay fees associated with its services for the clients 210 and in other embodiments, the clients 210 are responsible for negotiations with and payments to the authority 290. At 370, the service provider 250 presents or advertises itself to clients 210 over the communication network 240 to provide services or data 280 or any of many other activities provided over networks. At 380, the service provider initialization process 300 is completed. In some embodiments, the initialization process 300 is repeated for each service provided by the service provider 250 or for each unique service or group of services for which the service provider 250 requires differing levels of access (i.e., different access requirements may be placed on different services or data provided by the service provider and each such grouping can have its own verification process).

FIG. 4 presents a flow chart of an illustrative secure communication process 400 that occurs during the operation of a secure communication system of the invention (such as system 200). The client-service provider communications begin at 404 typically with an initial linking of the service provider 250 and the client 210 (and other clients) to a communication network 240. At 410, a request if received from a client 210 for services and/or access to the service provider 250. At 412, the service provider 250, such as with look up and verification tool 266, determines whether the requesting client 210 is a new client or a client already listed in an authorized client registry.

If the client 210 is new (e.g., not registered with the service provider 250), the process 400 continues at 414 with the service provider 250 collecting client registration information (alternatively, the client 210 may be directed to the certificate authority 290 to directly obtain keys and a client certificate). The client 210 typically generates a private key and stores this in its memory 212 in a private key file. The collected information includes a information required by the certificate authority 290 for requesting and obtaining a digital certificate signed by the authority 290. At 420, the service provider 250 (or ISP or client 210) contacts the certificate authority 290 to request a digital certificate for the requesting client 210 based on the collected information. If the client is verified authenticate by the authority 290, a client certificate is generated by the authority 290 and stored in memory 294 and at 426, the service provider 250 receives the client certificate 426 (with a public key). At 430, the client certificate 278 is stored in memory 270 and a copy is transmitted at 434 to the client 210 for storage/installation at 214 in memory 212. At 440, the client 210 generates a request that it transmits to the service provider 250 along with a copy of the digital certificate 214. The request or other messages transmitted from the client 210 are typically encrypted with the encryption tool 230 using the client's private key paired with the public key in the certificate 214.

Returning to 412, if the service provider 250 using the look up tool 266 determines the client is not new or is an authorized client, the process 400 continue at 450 with the service provider 250 retrieving a digital certificate stored in the client certificates 278 associated with the requesting client 210. At 456, the service provider 250, such as with the verification tool 266, compares a copy of the client certificate received with the request to the retrieved client certificate to verify the identity of the client 210. At 460, the service provider 250 decides if the request is from an authentic, authorized client 210. If not, the access request is refused at 464 and the process 400 continues at 410. If authenticated at 456 and 460, the service provider 250 generates a response to the client request and includes a copy of its digital certificate 274. At 476, the client 210 receives the response and certificate and determines whether the response is from a trusted or expected service provider 250 by using the verification tool 232 to compare the received certificate with a stored service provider certificate 216.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the invention was described using encryption based on private/public key pairs, but encryption is not necessary to practice the invention and when employed, can be any useful encryption technique. In some embodiments of the invention, the service provider or ISP acts to generate digital certificates for each registering client, thereby eliminating the need for involving a certificate authority in the initial registration of clients. In embodiments that utilize one or more certificate authorities, the secure communication method 400 of FIG. 4 may include periodically updating the service provider and client digital certificates and/or periodically modifying the public/private keys used for encryption.

In some cases the need for security is greater than in the described systems, and increased security can be provided in some embodiments by using biometrics by the client and/or service provider to initially obtain a digital certificate from a certificate authority and/or as part of message sent (i.e., as part of the identifying information or as part of the “digital certificate” which in this patent is intended to encompass any digital information used to identify a client or service provider including but not limited to digital certificate or IDs typically issued by certificate authorities).

We claim:

1. A computer-based method for providing secure communications between a service provider and clients, comprising:
receiving a request from a client with an identifier for the client;
authenticating an identity of the client by processing the client identifier; and
when the client authenticating verifies the client as authentic, generating a response to the client including an identifier for the service provider that can be used by the client in authenticating an identity of the service provider.

2. The method of claim 1, wherein the client identifier is a digital certificate issued by a certificate authority and includes a digital signature of the certificate authority.

3. The method of claim 1, wherein the request is encrypted and the authenticating includes decrypting the request with a client key.

4. The method of claim 1, wherein the service provider identifier is a digital certificate issued by a certificate authority, and further including authenticating at the client the identity of the service provider based on the service provider digital certificate.

5. The method of claim 4, wherein at least a portion of the service provider response is encrypted and the service provider authenticating includes decrypting the portion with a service provider key.

6. The method of claim 1, further including determining whether the client is a new client, and if determined to be new, contacting a certificate authority to request generation of a digital certificate signed by the certificate authority for the client, transferring a copy of the digital certificate to the client for use in generating a next request to the service providers, and storing a copy of the digital certificate in memory.

7. The method of claim 6, wherein the client identifier includes a copy of a digital certificate for the client issued by a certificate authority and further including if the client is determined not to be new, retrieving a copy of the client digital certificate, and further wherein the client authenticating includes comparing the retrieved client digital certificate with the copy of the digital certificate in the client identifier.

8. A method for providing secure digital data communications between a service device and a plurality of client devices, comprising:
at the service device, receiving from a first client device digital data including a digital certificate for the first client device;
first operating the service device to retrieve a copy of the digital certificate for the first client device;
second operating the service device to compare the received digital certificate for the first client device and the retrieved copy of the digital certificate for the first client device to authenticate the first client device; and
if the first client device is authenticated, third operating the service device to transmit a digital data response to the first client device including a digital certificate for the service device.

9. The method of claim 8, further including operating the first client device to receive the digital data response, retrieve a copy of the digital certificate for the service device, and compare the received digital certificate for the service device and retrieved copy of the digital certificate for the service device to authenticate the service device.

10. The method of claim 9, wherein the digital certificates are generated by a certificate authority and include a digital signature of the certificate authority.

11. The method of claim 8, further including receiving initial access requests from the first client device and a second client device, collecting identification information from the first and second client devices, requesting digital certificates for the first and second client devices from a certificate authority based on the collected identification information, and storing digital certificates for the first and second client devices in memory.

12. The method of claim 11, further including at the service receiving from the second client device digital data including a copy of the digital certificate for the second client device and operating the service device to retrieve the stored digital certificate for the second client device and authenticating the second client device by comparing the received copy and the retrieved digital certificate for the second client device.

13. A secure communications system, comprising:
a server linked to a digital communication network including memory storing a digital certificate for the service provider and a digital certificate for a plurality of client devices, a verification tool adapted for authenticating transmitting client devices by comparing received client digital certificates with the stored digital certificates for the client devices, and a response generator generating responses over the network including a copy of the digital certificate for the service provider; and
a client device linked to the network to allow communication with the server including memory storing a digital certificate for the client and a copy of the digital certificate for the server, a verification tool for authenticating the server by comparing received server digital certificates with the stored server digital certificate, and a request generator generating requests over the network including a copy of the stored digital certificate for the client.

14. The system of claim 13, further including a certificate authority server adapted to generate the digital certificates based on registration and right to use information from the server and the client device.

15. The system of claim 14, wherein the digital certificates include a public key for the server or the client device and are signed by the certificate authority.

16. The system of claim 13, wherein the server and the client each include an encryption tool for encrypting transmitted messages and decrypting received messages.

17. The system of claim 16, wherein the encrypting is performed using private keys and the decrypting is performed using public keys paired to the private keys.
